(19) United States
(12) Patent Application Publication
(10) Pub. No.: US 2012/0249731 A1
(43) Pub. Date: Oct. 4, 2012

(54) Method and Apparatus for Volumetric and Holographic Video, N-View Human Eye Depth Cuing Autostereoscopic Display and Transmission

(76) Inventors: Mark Zelinsky, Campbell, CA (US); William Gitow, San Jose, CA (US)

(21) Appl. No.: 13/434,776

(22) Filed: Mar. 29, 2012

Related U.S. Application Data
(60) Provisional application No. 61/469,787, filed on Mar. 30, 2011.

(51) Int. Cl. H04N 13/04; H04N 5/89

(52) U.S. Cl. 348/40; 348/E13.001

(57) ABSTRACT

The present invention is a general purpose, modular, portable, integrated system for synthesizing real-time color, depth, occlusion, and transparency data into formats for Volumetric and Holographic Rendering, Coding and Delivery.

Provisional Application 61/469,787 filing date of Mar. 30, 2011.

### BACKGROUND OF THE INVENTION

The present invention is in the technical fields of Lasers, Optics, Visualization, Displays, Parallel Architecture Video Processing, and Transmission.

More particularly, the present invention is in the technical field of Volumetric and Holographic Point Cloud Reality Capture, Rendering, and Delivery.

### BRIEF SUMMARY OF THE INVENTION

The present invention is a general purpose, modular, portable, integrated system for synthesizing real-time color, depth, occlusion, and transparency data into formats for Volumetric and Holographic Rendering, Coding and Delivery.

### BRIEF DESCRIPTION OF THE DRAWINGS

FIG. 1 is a general view of the general purpose, modular, portable, integrated Platform of the present invention;

FIG. 2 is the Single Point Illuminator Camera of the present invention;

FIG. 3 is the Frame by Frame Broadcast Illuminator Camera of the present invention;

FIG. 4 is the N-View Human Eye Depth Cuing Autostereoscopic Display of the present invention;

### DETAILED DESCRIPTION OF THE INVENTION

The present invention is directed to the Method and Apparatus for Volumetric and Holographic Video, N-View Human Eye Depth Cuing Autostereoscopic Display, and Transmission.

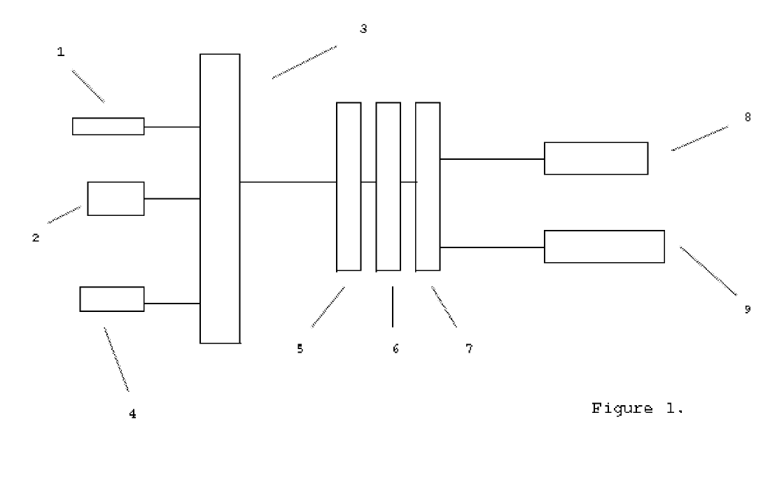

FIG. 1 shows in more detail the general purpose, modular, portable, integrated, compatible Platform. Single Point Illuminator Camera 1 and Frame by Frame Broadcast Illuminator Camera 2 collect real-time color, depth, occlusion, and transparency data for Volumetric and Holographic Production 3. Other inputs for 3D Production are Computer 3D Graphics and Design, 2D to 3D, Stereo 3D, Motion, Gestures, and Multiple Cameras 4. Parallel Video Processing Rendering 5, N-View Human Eye Depth Cuing coding 6, and Transmission 7 to a N-View Human Eye Depth Cuing Autostereoscopic Volumetric and Hybrid and Holographic Display 8 and Z Data Streaming for Computer Graphics, 3D Printers, Head and Eye Displays, 3D Data Storage, Holograms 9.

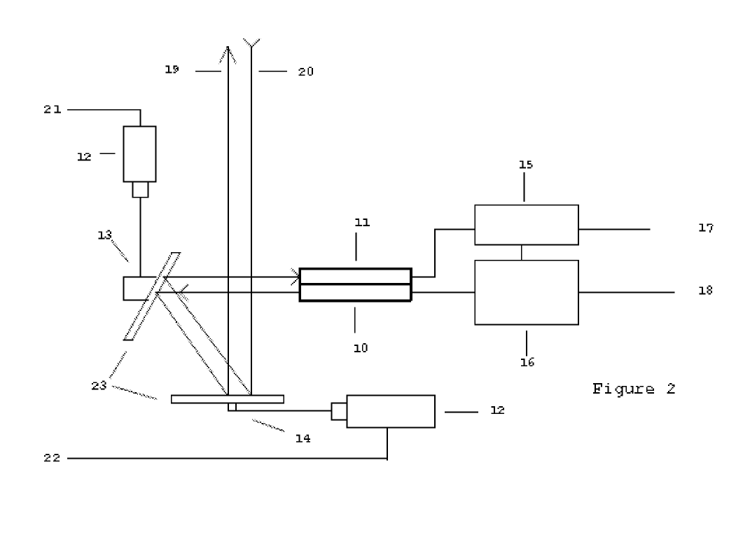

FIG. 2 shows in more detail the Single Point Illuminator Camera. The Single Point Illuminator Camera consists of a Laser Illuminator 10, Single Point Laser Detector 11, and Laser Steering device such as a Galvo, Resonant Scanner, or Switched Reluctance Motor 12. Horizontal 13 and Vertical 14 deflection, a Phase/time Comparator 15, and Laser Oscillator/driver 16 acquire the depth or Z axis data 17. The Laser Illuminator 10 has a focused low power laser/driver with ample power to illuminate various colors, emissivities, and will work in direct sunlight, for long distances, sending a raster to the target object. The focused Laser Single Point Detector 11 sees where the Laser is aimed thus minimizing multi-path error. Missed distance bits can be remeasured without scanning the entire scene. I/O signals are: Reference input times the laser pulses 18, laser out 19, laser return 20, H position in 21, and V position in 22. Deflection mirrors 23. A Single Point Illuminator and a Broadcast Illuminator can be combined for dual Illumination.

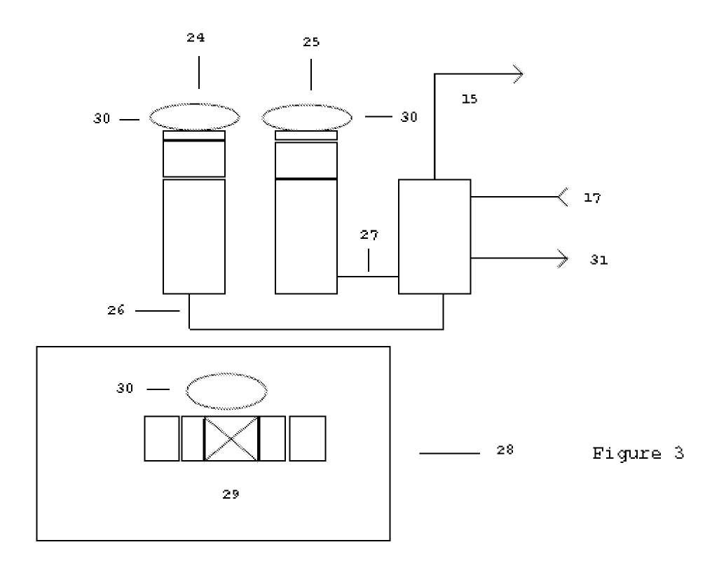

FIG. 3 shows in more detail the Frame by Frame Broadcast Illuminator Camera for capture indoors and for short distances. Two camera assemblies shown for the Frame by Frame Broadcast Illuminator Camera; Image 24 and Infra Red 25. The Camera sections are in sync, acquiring the same area of the shoot at the same time. The Illuminator 10 uses the Camera sync to line up the Depth data 25 with the RGB data 25, as the cameras are doing data acquisition. The Illuminator signal 19 is broadcast as a full field rather than single point and compared against the signal 20 coming into the Infra Red section 25. The Timing/phase difference 27 measured between signals produces Video accompanied by Depth information 31. The Pixel by Pixel Lens focus system 28 uses the same information using a beam splitter 29 that allows both color and depth data to go thru a single lens 30. The color and depth data 31 is ready to process for rendering.

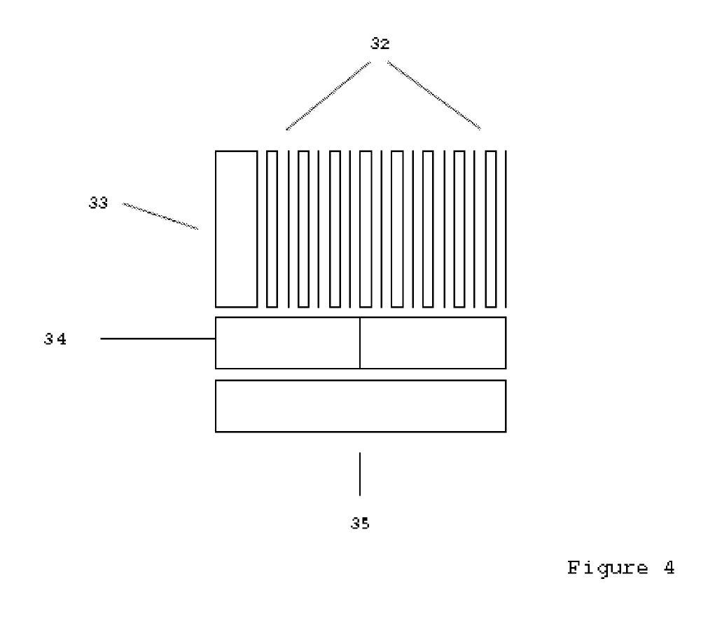

FIG. 4 shows in more detail the N-View Human Eye Depth Cuing Autostereoscopic Display 3. There are N number of fields, with each field containing a hologram 32. A specialized backlight 33, Video processor/Display driver 34 and multimode power supply 35.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. Personal volumetric and holographic point cloud video capture, processing, visualization display and self-publishing exploitation.
